(19) United States
(12) Patent Application Publication
(10) Pub. No.: US 2005/0269988 A1
(43) Pub. Date: Dec. 8, 2005

(54) Voltage balancing circuit for multi-cell modules

(75) Inventor: Guy C. Thrap, Del Mar, CA (US)

Correspondence Address: Gregory J. Koerner;Redwood Patent Law, 1291 East Hillsdale Boulevard, Suite 205, Foster City, CA, 94404, US

(73) Assignee: Maxwell Technologies, Inc., San Diego, CA (US)

(21) Appl. No.: 10/948,892

(22) Filed: Sep. 24, 2004

Related U.S. Application Data
(63) Continuation-in-part of application No. 10/860,965, filed on Jun. 4, 2004.

(51) Int. Cl. H02J 7/00

(52) U.S. Cl. 320/116

(57) ABSTRACT

An energy storage module includes a number of cells coupled in series between two end terminals, and intermediate terminal or terminals providing access to one or more junctions between individual cells of the module. Voltages of the module's cells are balanced by an intra-module voltage balancer. Two or more such modules are connected in series. To balance voltages of the modules, inter-module voltage balancers are used. In one embodiment, an inter-module voltage balancer is connected to a junction of two modules and to intermediate terminals of the two modules. The inter-module balancer attempts to balance voltages of one or more cells of one of the two modules against one or more cells of the other module. Through operation of the intra-module balancers of each module, voltages of both modules are balanced.

### RELATED APPLICATION

The present invention is a CIP of commonly assigned U.S. patent application Ser. No. 10/860,965, filed 4 Jun. 2004, Attorney Docket No. M111US, from which priority is claimed.

### FIELD OF THE INVENTION

The present invention relates generally to circuits for balancing voltages, and, more specifically, to circuits for balancing voltages of multi-cell energy storage modules.

### BACKGROUND

Energy storage devices are often constructed of individual cells connected in series within a common enclosure or module. Output terminals typically provide access to the combined voltage of the series cell combination. Such modules provide nominal operating voltages higher than those available from each individual cell. When charging a number of individual energy storage cells connected in series, different rates of accepting charge and different voltage responses to the charge can cause some of the cells to have higher voltages than other cells. Similarly, discharging a series combination of cells can result in voltage imbalances from cell to cell. These phenomena are problematic for at least two related reasons.

First, excessive voltage (overvoltage) across a cell can shorten the life of the cell, and, consequently, shorten the life of the module in which the cell is installed. Overvoltage can also cause a catastrophic failure of the cell and the module. To avoid such failures, modules may provide a safety margin, with the maximum voltage rating of a module set below the sum of the voltage ratings of the module's constituent cells. This approach lowers the energy capacity of the module, and may be not entirely foolproof.

Second, an overvoltage condition of some cells may cause lower than average voltage (undervoltage) in other cells. The cells with low voltages may then accept less energy and, thus, be underutilized, also resulting in a lower stored energy capacity of the module.

It follows that, ideally, all cells of a module should be identical, so that the cells accept and release electrical charge at the same rate such that their voltages closely track each other. In practice, however, cell characteristics vary from cell to cell. This is particularly true when the cells have not been matched to each other. But matching cells is an additional step in the manufacturing process, which may increase the cost of the modules. Moreover, the original match is hardly ever perfect; the closer the required match, the costlier the matching step becomes. And even closely-matched cells may age differently, with increasing divergence in their performance characteristics over both charge-discharge cycles and chronological age.

To minimize problems associated with cell imbalance, some modules employ cell voltage balancers (also known as voltage equalizers) across the cells to help keep the cell-to-cell voltage variations within a module relatively low. In this document, such balance will be referred to as intra-module voltage balance.

Individual modules may themselves also be connected in series to achieve operating voltages higher than those available from each individual module. In practice, for reasons similar to those that cause cell-to-cell voltage variations discussed above, each module may exhibit different operating characteristics. Thus, module-to-module voltage imbalance (inter-module imbalance) may arise, whereby some modules may have higher voltages than other modules. If identical modules could be selected for the series combination, the voltages across each module would likely be about the same. Such balance will be referred to as inter-module balance.

Although overvoltage of the individual constituent cells may be avoided, in some circumstances, because of the presence in the modules of internal cell voltage balancers (i.e., intra-cell voltage balancers), module-to-module voltage imbalance may nevertheless occur. For example, inter-module imbalance may limit the total voltage and energy available from the series combination of the modules, and reduce energy efficiency of the series combination of modules. Moreover, certain cell voltage balancers might not prevent cell overvoltage if the entire module is overcharged. To reduce the problems associated with module-to-module voltage imbalance, conventional voltage balancers can be used to balance multiple modules against each other in a way that is similar to the use of voltage balancers to equalize voltages of the individual cells. Two related problems, however, arise when implementing such balancing in practice.

First, the module voltage balancers (inter-module voltage balancers) used in such applications need to be rated for the full voltage available from a module. When the module includes two individual cells, for example, the voltage rating is twice that of each individual cell. Often, modules include a large number of cells, resulting in commensurately higher required voltage ratings.

Second, even assuming the same balancing current for a module as that for an individual cell, the power rating of each module balancer increases by the same factor as the voltage rating. Thus, a voltage balancing circuit designed to balance 50-volt modules using 300 milliamperes should be capable of handling fifteen watts. This problem naturally increases with increasing currents, which can be important when balancers are also used to charge modules using cells capable of receiving high currents, such as modules built with double layer capacitor cells.

Thus, when voltage balancer techniques are applied to module-to-module voltage balancing, cost, size, and performance characteristics that are undesirable need to be addressed.

### SUMMARY

A need thus exists for multi-cell modules capable of being equalized using voltage balancers with relatively low voltage and low power rated components. Another need exists for multi-cell module balancing techniques using voltage balancers with relatively low voltage and power rated components. A further need exists to provide voltage balancers that can be constructed with components having relatively low voltage and power ratings, but capable of balancing multi-cell modules.

The present invention is directed to an electric energy storage module that includes first and second end terminals, a plurality of energy storage cells connected in series between the first and second end terminals to provide voltage output from the end terminals, a holder capable of holding the plurality of energy storage cells, an intra-module voltage balancer capable of equalizing voltages of the energy storage cells, and an intermediate terminal coupled to a common junction of two of the energy storage cells. The intermediate terminal and the end terminals are externally accessible.

In various embodiments of the module, the cells include capacitors, such as double layer capacitors, and other rechargeable cells. The holder can be an enclosure containing the cells and the intra-module voltage balancer. The intra-module balancer can include a flyback circuit or a shunt balancer. The intermediate terminal can be coupled in the middle of the series of the energy storage cells, so that exactly the same number of energy storage cells are present between the intermediate terminal and each of the end terminals. In some embodiments, two intermediate terminals are present, each intermediate terminals being connected to a different junction of two of the energy storage cells. The same number of energy storage cells can be present between each intermediate terminal and the end terminal nearest the intermediate terminal. More than two intermediate terminals are present in some embodiments.

The present invention is also directed to energy storage apparatus built with a plurality of energy storage modules, such as the modules described above. The modules are connected in series and their voltages are equalized by one or more inter-module voltage balancers. In one embodiment, the inter-module balancer is coupled to the junctions of adjacent modules, and to the intermediate terminals of the modules.

In operation, the inter-module balancer equalizes voltages of a subset of one or more cells of each module. Because the intra-module balancers (internal to the modules) attempt to equalize the voltages of all cells of a given module, equalizing voltages of subsets of the cells tends to equalize the voltages of the entire modules.

In one embodiment, an electric energy storage module comprise a first end terminal and a second end terminal; a plurality of energy storage cells connected in series between the first end terminal and a second end terminal to provide voltage output from the first and the second end terminals; a holder capable of holding the plurality of energy storage cells; an intra-module voltage balancer capable of equalizing voltages of the energy storage cells; and at least one intermediate terminal coupled to one or more common junction of two of the energy storage cells; wherein the first end terminal, the second end terminal, and the at least one intermediate terminal are externally accessible. The holder may comprise an enclosure surrounding and containing the plurality of energy storage cells and the intra-module voltage balancer. The plurality of energy storage cells may comprise a plurality of double layer capacitors. Each energy storage cell of the plurality of energy storage cells may comprise a capacitor. The plurality of energy storage cells may comprise a plurality of secondary cells. The intra-module voltage balancer comprises a flyback circuit. The intra-module voltage balancer may comprise a shunt balancer. The intra-module balancer may comprise an active balancer. The at least one intermediate terminal may include one intermediate terminal coupled to a first common junction of two of the energy storage cells, wherein the first common junction is in the middle of the series of the energy storage cells so that exactly a first number of energy storage cells may be present between the first common junction and the first end terminal, and wherein exactly the first number of energy storage devices may be present between the first common junction and the second end terminal. The first number may be equal to one. The at least one intermediate terminal may include a first intermediate terminal coupled to a first common junction of two of the energy storage cells, and a second intermediate terminal coupled to a second common junction of two of the energy storage cells, wherein a first number of energy storage cells may be present between the first common junction and the first end terminal, and wherein the first number of energy storage cells may be present between the second common junction and the second end terminal. The first number may equal to one. The first number may be greater than one.

In one embodiment, an energy storage apparatus comprises a plurality of energy storage modules; and one or more inter-module voltage balancer connected to the plurality of energy storage modules to equalize voltages of the modules; wherein each module of the plurality of energy storage modules comprises a first end terminal and a second end terminal, a plurality of energy storage cells connected in series between the first end terminal and a second end terminal of said each module to provide voltage output from the first and the second end terminals of said each module, a holder capable of holding the plurality of energy storage cells of said each module, an intra-module voltage balancer capable of equalizing voltages of the energy storage cells of said each module, and at least one intermediate terminal coupled to one or more common junctions of two of the energy storage cells of said each module; and wherein the first end terminal, the second end terminal, and the at least one intermediate terminal of said each module are externally accessible and connected to the at least one inter-module voltage balancer. The holder of said each module may comprise an enclosure surrounding and containing the plurality of energy storage cells of said each module and the intra-module voltage balancer of said each module. The inter-module voltage balancer may equalize voltages of combinations of fewer than all cells of said each module, and indirectly equalize voltages of the modules. The at least one intermediate terminal of said each module includes one intermediate terminal coupled to a first common junction of two of the energy storage cells of said each module, wherein the first common junction of said each module is in the middle of the series of the energy storage cells of said each module so that exactly a first number of energy storage cells are present between the first common junction and the first end terminal of said each module, and wherein exactly the first number of energy storage devices are present between the first common junction and the second end terminal of said each module. The first number may equal to one. The first number may be greater than one. The plurality of energy storage cells of said each module may comprise a plurality of double layer capacitors. The at least one intermediate terminal of said each module may include an intermediate terminal coupled to a first common junction of two of the energy storage cells of said each module, and a second intermediate terminal coupled to a second common junction of two of the energy storage cells of said each module; wherein a first number of energy storage cells are present between the first common junction and the first end terminal of said each module, and wherein the first number of energy storage cells are present between the second common junction and the second end terminal of said each module. The first number may equal to one. The first number may be greater than one. The inter-module balancer may comprise a flyback circuit. The inter-module balancer may comprise a shunt balancer. The inter-module balancer may comprise an active balancer. The plurality of energy storage cells of said each module may comprise a plurality of double layer capacitors.

In one embodiment, an energy storage device comprises a first module comprising a first end terminal and a second end terminal, a first plurality of energy storage cells connected in series between the first end terminal and the second end terminal to provide voltage output from the first and the second end terminals, a first holder capable of holding the first plurality of energy storage cells, a first intra-module voltage balancer capable of equalizing voltages of the energy storage cells of the first plurality, and a first intermediate terminal coupled to a common junction of two of the energy storage cells of the first plurality, wherein the first end terminal, the second end terminal, and the first intermediate terminal of the first module are externally accessible; a second module comprising a third end terminal and a fourth end terminal, a second plurality of energy storage cells connected in series between the third end terminal and the fourth end terminal to provide voltage output from the third and the fourth end terminals, a second holder capable of holding the second plurality of energy storage cells, a second intra-module voltage balancer capable of equalizing voltages of the energy storage cells of the second plurality, and a second intermediate terminal coupled to a common junction of two of the energy storage cells of the second plurality, wherein the third end terminal, the fourth end terminal, and the second intermediate terminal are externally accessible; and an inter-module voltage balancer; wherein the first module and the second module are connected in series so that the second end terminal of the first module is coupled to the third end terminal of the second module; and the inter-module voltage balancer is connected to the second end terminal of the first module, the first intermediate terminal of the first module, and to the second intermediate terminal of the second module to equalize directly voltage of cells located between the first intermediate terminal and the second end terminal of the first module and voltage of cells located between the second intermediate terminal and the third end terminal of the second module. The first holder may comprise a first enclosure surrounding and containing the first plurality of energy storage cells and the first intra-module voltage balancer, and the second holder may comprise a second enclosure surrounding and containing the second plurality of energy storage cells and the second intra-module voltage balancer. The first plurality of cells may comprise a plurality of double layer capacitors, and the second plurality of cells may comprise a plurality of double layer capacitors. One cell may be located between the first intermediate terminal and the second end terminal of the first module, and one cell may be located between the second intermediate terminal and the third end terminal of the second module. Exactly the same number of cells may be located between the first intermediate terminal and the second end terminal of the first module as the number of cells located between the second intermediate terminal and the third end terminal of the second module. At least two cells may be located between the first intermediate terminal and the second end terminal of the first module.

In one embodiment, a method of equalizing voltages of rechargeable multi-cell modules with intra-module voltage balancers includes the modules being connected in series, each module comprising a plurality of energy storage cells connected in series between a first end terminal and a second end terminal, the method comprising providing an inter-module voltage balancer; connecting the inter-module voltage balancer junctions between two adjacent modules of the plurality of modules; and operating the inter-module voltage balancer to balance directly voltages of combinations of fewer than all cells of each module, thereby equalizing indirectly voltages of the modules.

In one embodiment, an energy storage system comprises a plurality of modules, each module comprising a plurality of interconnected double-layer capacitors; one or more intra-module balancer, wherein between each double-layer capacitor there is interconnected one intra-module balancer to equalize voltages of the double-layer capacitors; and one or more inter-module balancer, wherein between each module there is interconnected one inter-module balancer to equalize voltages appearing across the modules. The energy storage system may comprise an enclosure surrounding and containing the interconnected double-layer capacitors. The inter-module balancer may equalize voltages across one or more double-layer capacitor in one module against voltages across one or more double-layer capacitor in a second module. The voltages across the one or more double-layer capacitor may be less than the voltages across the modules.

These and other features and aspects of the present invention will be better understood with reference to the following description, drawings, and appended claims.

### BRIEF DESCRIPTION OF THE FIGURES

FIG. 1 illustrates selected elements of a two-cell energy storage module, in accordance with aspects of the present invention;

FIG. 2 illustrates selected elements of an energy storage module with more than two cells, in accordance with aspects of the present invention;

FIG. 3A illustrates selected elements of a combination of four multi-cell energy storage modules coupled in series and balanced with inter-module voltage balancers, according to aspects of the present invention;

FIG. 3B illustrates selected interconnections of the combination of FIG. 3A;

FIG. 4 illustrates selected elements of a combination of energy storage modules with an inter-module voltage balancer, in accordance with aspects of the present invention;

FIG. 5 illustrates selected elements of another combination of energy storage modules with an inter-module voltage balancer, in accordance with aspects of the present invention; and

FIG. 6 illustrates selected elements of a combination of multi-cell modules with a flyback circuit used for inter-module voltage balancing, in accordance with aspects of the present invention.

### DETAILED DESCRIPTION

Reference will now be made in detail to several embodiments of the invention that are illustrated in the accompanying drawings. Same or similar reference numerals may be used in the drawings and the description to refer to the same or like parts. The drawings are in a simplified form and not to precise scale. For purposes of convenience and clarity, directional terms such as top, bottom, left, right, up, down, over, above, below, beneath, rear, and front may be used with respect to the accompanying drawings. These and similar directional terms should not be construed to limit the scope of the invention in any manner.

In this description, the words “embodiment” and “variant” refer to a particular apparatus or process, and not necessarily to the same apparatus or process. Thus, “one embodiment” (or a similar expression) used in one place or context can refer to a particular apparatus or process; the same or a similar expression in a different place can refer to a different apparatus or process. The expression “alternative embodiment” and similar phrases are used to indicate one of a number of possible embodiments. The number of possible embodiments is not limited. The words “couple,” “connect,” and similar terms with their inflectional morphemes are used interchangeably, unless the difference is noted or otherwise made clear from the context. These words and expressions do not necessarily signify direct connections, but include connections through mediate components and devices. The word “module” may be used interchangeably with other equivalent terms to signify a unit of energy storage cells coupled within a common holder (e.g., an enclosure or another device for holding the cells together) that has output terminals for providing access to the combined voltage of the cell combination. Additional definitions and clarifications may be interspersed in the text of this document.

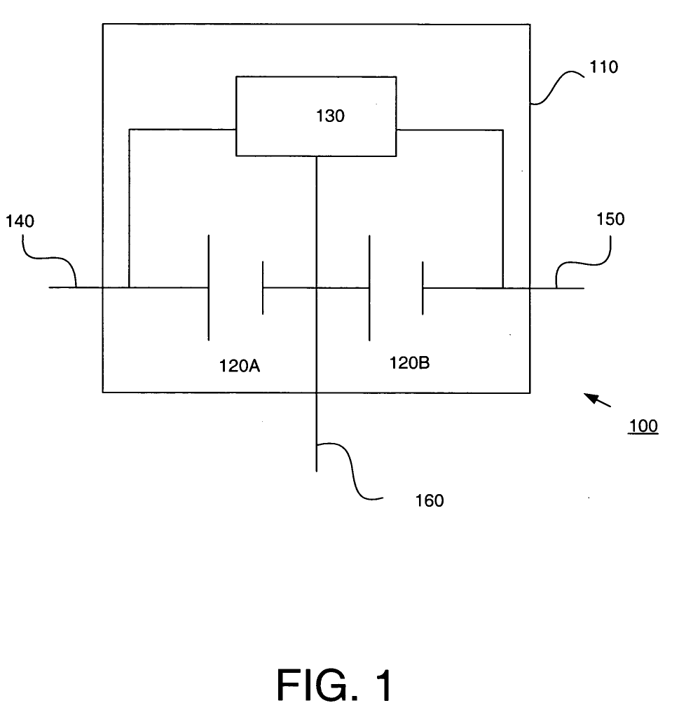

FIG. 1 is a high-level illustration of a two-cell energy storage module 100 in accordance with aspects of the present invention. The module 100 includes two individual energy storage cells 120A and 120B coupled in series between a positive end terminal 140 and a negative end terminal 150. An intermediate terminal 160 is coupled to the junction between the individual energy storage cells 120A and 120B. Reference numeral 130 designates an intra-module voltage balancer, which is coupled across each of the individual energy storage cells 120A and 120B. The voltage balancer 130 and the energy cells 120 are surrounded and contained in an enclosure 110. The terminals 140, 150, and 160 are accessible from outside of the enclosure 110 and can be used to couple the module 100 to external devices. In operation, the module 100 is charged through the terminals 140 and 150, and then provides energy through the same terminals during discharge cycles. The intra-module voltage balancer 130 maintains approximate voltage balance between the individual energy storage cells 120A and 120B.

In the illustrated embodiment, the cells 120A and 120B are double layer capacitor cells, which are known for their high capacitance per unit weight and per unit volume. Double layer capacitors are also known as ultracapacitors or supercapacitors. Generally, modules used in accordance with embodiments of the present invention can include double layer capacitor cells as well as energy storage cells built with other technologies. For example, capacitive cells built with conventional technologies, and electrochemical and other secondary (rechargeable) cells can be used for constructing modules.

The intra-module voltage balancer 130 can be, for example, an active balancer, a shunt balancer, or a flyback circuit balancer. An active balancer is described in currently pending commonly assigned patent application Ser. No. 10/423,708, Docket No. 501, which is incorporated herein by reference.

A shunt balancer can provide a controlled parallel connection across an individual cell to limit current into the cell (or drain current form the cell) under certain conditions, such as when the voltage of the cell exceeds a predetermined level. For example, voltage across an individual cell can be compared, directly or indirectly, to a voltage generated by a stable voltage reference, and a solid state switch can be opened or closed depending on the result of the voltage comparison. When the comparison indicates an overvoltage condition, the switch is closed, shunting the current between the cell's terminals. many shunt circuits and variations thereof are known to those skilled in the art.

A flyback balancer can include a transformer with a primary winding and a plurality of substantially identical secondary windings. Each secondary winding is connected across one of the module's cells. To prevent the cells from discharging through their associated windings, diodes are inserted in series with the windings. A power source for charging the module is then connected to the primary winding through a switch. The state of the switch is controlled by an alternating signal from an oscillator. When the oscillator causes the switch to open, magnetic energy stored in the transformer core “flies” into the individual cells, with more energy charging the cells that have low voltages. The cell voltages thus are brought into balance.

In some embodiments, the voltage balancer 130 acts during charge cycles only. In other embodiments, the voltage balancer 130 acts during both charge and discharge cycles, for example, as described in currently pending commonly assigned patent application Ser. No. 10/860,965, Docket No. M113US, which describes a novel variant of a flyback balancer circuit and which is incorporated herein by reference. Embodiments with voltage balancers that operate only during discharge cycles, only during storage periods, or during any combination of storage periods and charge and discharge cycles, thus, fall within the scope of the present invention.

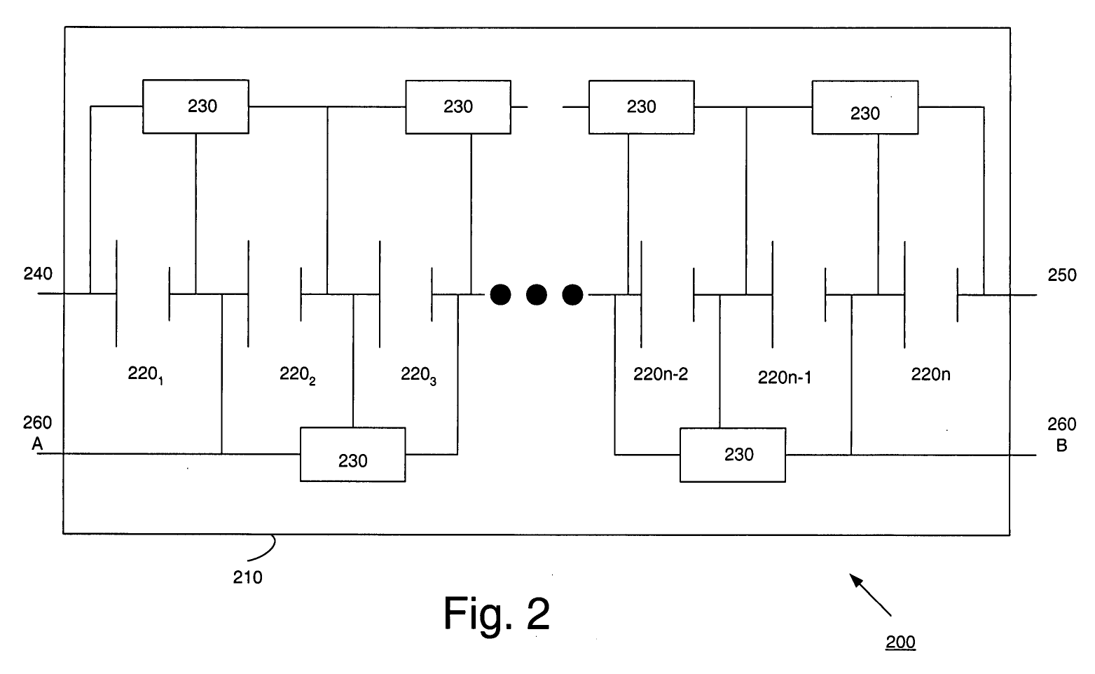

FIG. 2 is a high-level illustration of an N-cell energy storage module 200 where N is greater than two, in accordance with aspects of the present invention. In this embodiment, N individual energy storage cells 220, through 22N are coupled in series between a positive end terminal 240 and a negative end terminal 250. A voltage balancer 230 includes connections that couple the voltage balancer 230 across each of the individual energy storage cells 220. The voltage balancer 230 equalizes the voltages of the individual cells 220, bringing these voltages into approximate balance. An intermediate terminal 260A is coupled to the junction between the cells 220, and 2202. Similarly, an intermediate terminal 260B is coupled to the junction between the cells 220_{N} and 220_{N-1}. The cells 220 and the voltage balancer 230 are contained in an enclosure 210. The terminals 240, 250, 260A, and 260B are externally accessible. This embodiment does not contain external connections to junctions between the individual cells 220, except for the intermediate terminals 260A and 260B. Other embodiments may include such connections.

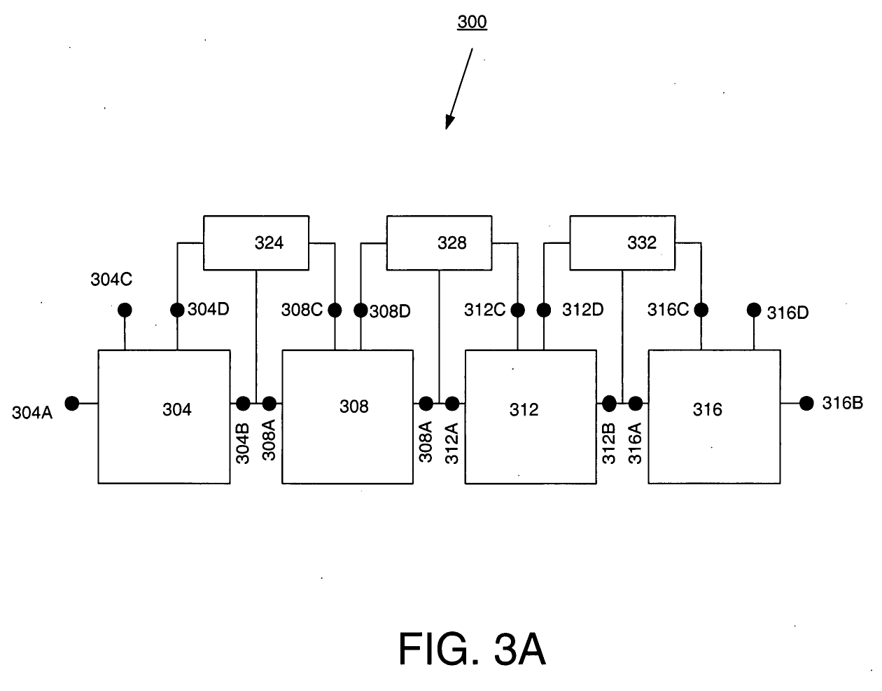

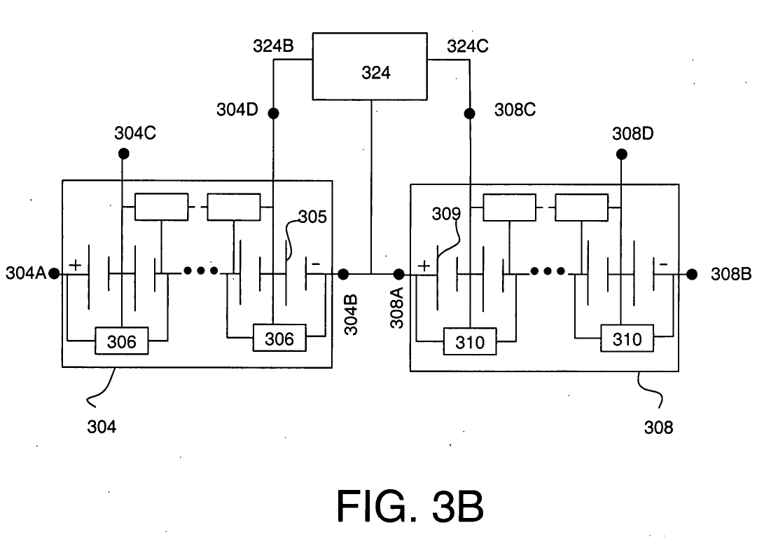

FIG. 3A is a high-level illustration of a combination 300 of four multi-cell energy storage modules 304, 308, 312, and 316 coupled in series and balanced with inter-module balancers 324, 328, and 332, according to aspects of the present invention.

Each of the energy storage modules 304, 308, 312, and 316 includes a number of individual energy storage cells coupled in series between a pair of external end terminals. The external end terminals are designated with reference numerals 304A, 304B, 308A, 308B, 312A, 312B, 316A, and 316B. Each module further includes one or more intra-module voltage balancer for equalizing the voltages of the individual cells. The individual cells, the intra-module voltage balancers, and internal module interconnections are not specifically shown in the Figure, but are similar to those illustrated in FIG. 2, and should be understood by a person skilled in the appropriate art. Each module also includes a pair of intermediate terminals. The intermediate terminals illustrated in FIG. 3A include terminals 304C, 304D, 308C, 308D, 312C, 312D, 316C, and 316D.

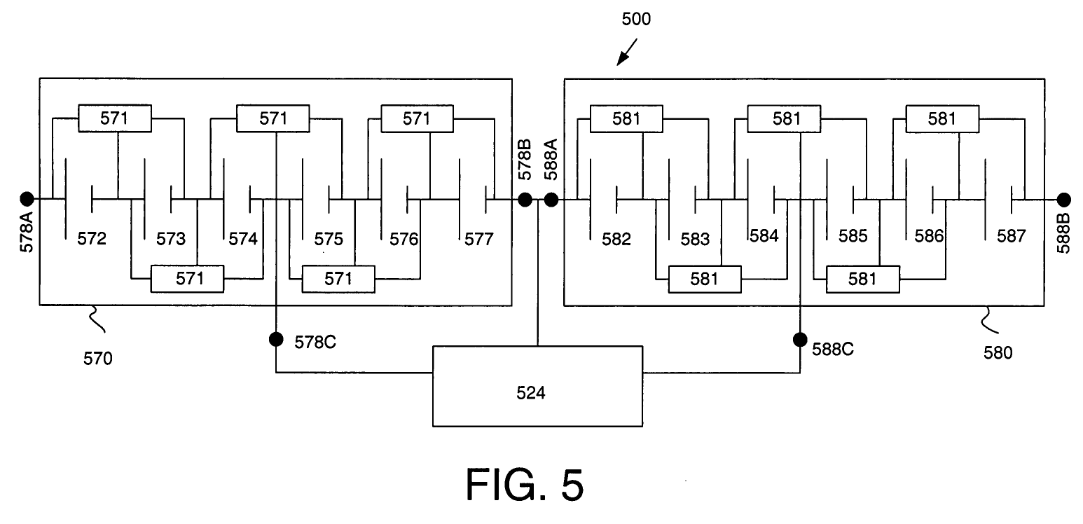

In the embodiment of FIG. 3A, each intermediate terminal of a module is separated from an end terminal of the module by one cell. For example, one cell is coupled between terminals 304A and 304C, and one cell is coupled between terminals 304B and 304D. The same arrangement exists in the modules 308, 312, and 316. Note that in embodiments where each module includes only two cells, a single intermediate terminal suffices; in effect the terminals 304C and 304D would then be combined into the single terminal. Such module 100 was illustrated in FIG. 1 and discussed above. As will be seen from the discussion accompanying FIG. 5, a single intermediate terminal can be used even where each module includes more than two cells.

The combination 300 further includes three inter-module voltage balancers, which are designated with reference numerals 324, 328, and 332. The inter-module balancers 324, 328, and 332 may be of an active, shunt, flyback circuit configuration as described herein. The inter-module balancers 324, 328, and 332 help to bring the voltages output by each of the modules 304, 308, 312, and 316 into approximate balance, i.e., into approximate parity with each other.

To help describe operation of the combination 300, FIG. 3B illustrates in more detail interconnections of the inter-module voltage balancer 324, and the modules 304 and 308. Note that end cell 305 of the module 304 is connected between the terminals 304B and 304D of that module. Similarly, end cell 309 of the module 308 is connected between the terminals 308A and 308C of the same module. The inter-module balancer 324 is connected so that its common terminal 324A is coupled to the common junction of the modules 304 and 308, i.e., to the terminals 304B and 308A. Terminals 324B and 324C of the balancer 324 are connected to the intermediate terminals 304D and 308C, respectively. Thus, the balancer 324 is positioned so that it can balance the voltages of the cells 305 and 309 against each other. For example, the balancer 324 can transfer energy from the cell with the higher voltage into the cell with the lower voltage.

The inter-module balancer 324 is not the only device affecting the voltages on the cells 305 and 309. Recall that the cells 305 and 309 are also connected to intra-module voltage balancers; in FIG. 3B, these intra-module balancers are designated with reference numerals 306 and 310, respectively. Although inter-module balancer 324 increases or decreases the cell voltage of cells 305 and 309, intra-module balancers 306 and 310 also act to increase or decrease the voltages of cells (including cells 305 and 309) within the modules. Voltage balance among cells within a module is propagated by the intra-module balancers 306 and 310 and between modules via inter-module balancer 324. Similarly, voltage imbalances appearing between modules are equalized by inter-module balancer 324 and, in turn this equalized voltage is propagated by the inter-module balancers 306 and 310 to cells within a module. In other words, inter-module balancer 324, by directly balancing voltages of individual cells 305 and 309 tends to indirectly balance the voltage of the modules 304 and 308. (“Directly” here signifies an immediate causal connection between operation of the inter-module balancer and its effect on the voltages of the individual cells 305 and 309; “indirectly” signifies causal connection through operation of intermediate devices, which are intra-module balancers 306 and 310 in this example.)

Note that the voltages appearing across the terminal 324A and either one of the terminals 324B or 324C are essentially voltages of the cells 305 or 309. Thus, the components of the inter-module balancer 324 may (but need not) be rated for voltages less than those that can be sourced by the complete modules 304 or 308.

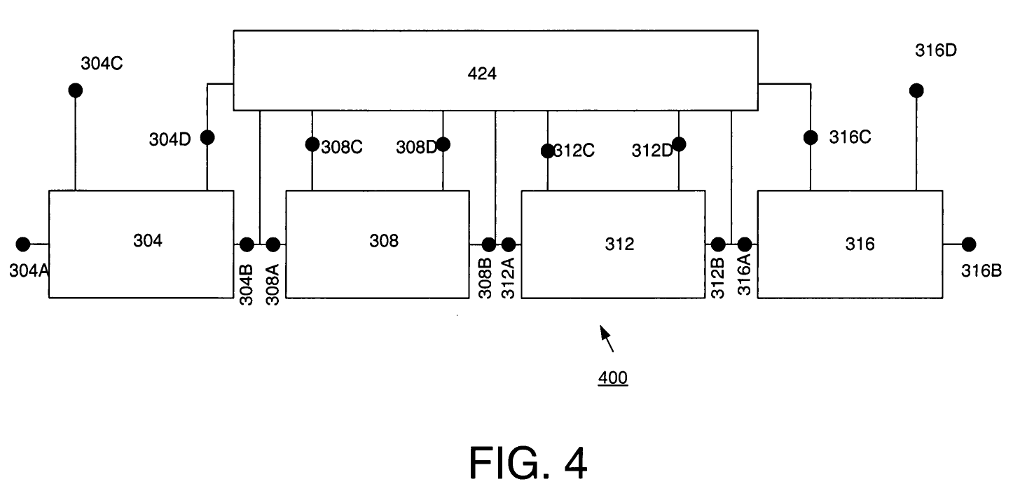

Although FIG. 3A illustrates the inter-module voltage balancers 324, 328, and 332 as separate devices, this is not a requirement of the invention. Indeed, multiple inter-module balancers can be advantageously built as a single device. FIG. 4 illustrates a combination 400 of energy storage modules with a single inter-module voltage balancer. The arrangement of FIG. 4 is similar to that of FIG. 3A, and most apparatus elements are designated with the same numerals in the two Figures. In FIG. 4, however, a single inter-module voltage balancer 424 may be configured to perform the module voltage equalization performed by balancers 324, 328, and 332 in the embodiment of FIG. 3A.

In the embodiments described above, a single cell is coupled between each intermediate terminal and the nearest end terminal of a module. See, for example, cells 305 and 309 in FIG. 3B. This, however, is not a requirement of the invention. FIG. 5 shows adjacent multi-cell modules 570 and 580 of a combination 500. The module 570 includes six energy storage cells (572, 573, 574, 575, 576, and 577) coupled in series between end terminals 578A and 578B. Intermediate terminal 578C connects to the common junction of the middle cells 574 and 575. An intra-module voltage balancer 571 equalizes the voltages of the individual cells 572 through 577. Layout of the module 580 is the same as that of the module 570. Here, the cells are designated with reference numerals 582 through 587, the intra-module balancer is designated with numeral 581, the intermediate terminal is designated as 588C, and the end terminals are designated as 588A and 588B. An inter-module voltage balancer 524 connects to the intermediate terminals 578C and 588C, and to the common junction of the modules 570 and 580.

In operation, each of the intra-module balancers 571 and 581 equalizes the cell voltages within its respective module. At the same time, the inter-module balancer 524 attempts to equalize (directly) the combined voltage of the cells 575, 576, and 577 against the combined voltage of the cells 582, 583, and 584. Intuitively, this is similar to equalizing voltages of a single cell of one of the modules and a single cell of the other module, as was described above with reference to FIG. 3B. In essence, decreasing or increasing the combined voltage of each trio of cells (575/576/577 and 582/583/584) tends, over time, to increase or decrease the combined voltages of all cells within the respective modules through operation of the intra-cell voltage balancers 571 and 581. In this way, the inter-module voltage balancer 524 tends to balance indirectly the voltages of the modules 570 and 580.

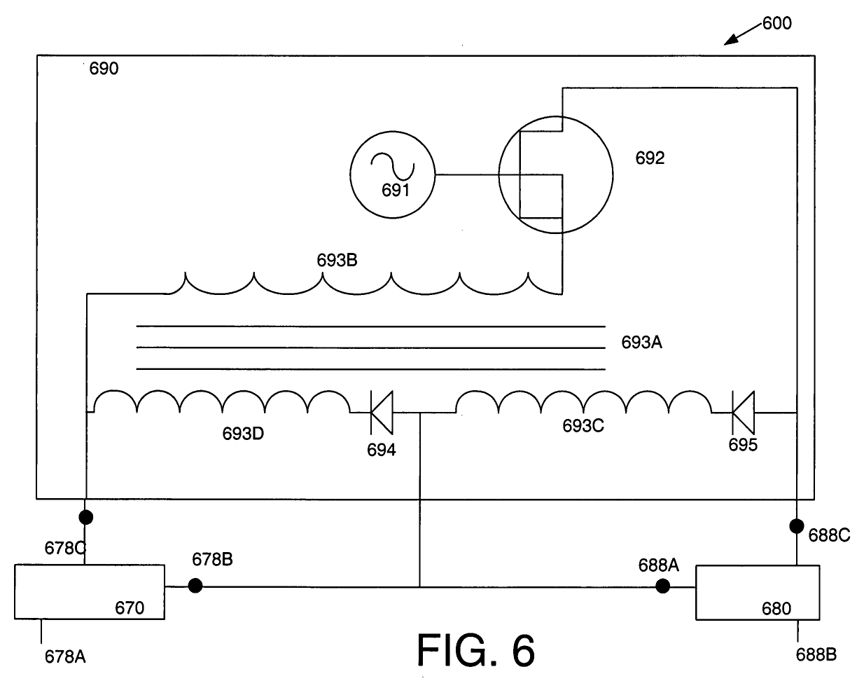

Various voltage balancing schemes can be used for constructing inter-module balancers, such as balancers 324, 424, and 524 discussed above. One exemplary embodiment uses a flyback circuit for this purpose. FIG. 6 illustrates a combination 600 of multi-cell modules 670 and 680 with such a flyback circuit 690. The flyback circuit 690 includes a transformer 693 with a core 693A, primary winding 693B and secondary windings 693C and 693D. The primary winding 693B is coupled in series with a solid state switch 692, such as a field effect transistor (FET) device. The series combination of the primary winding 693B and the switch 692 is coupled across intermediate terminals 678C and 688C of the modules 670 and 680. Each of the secondary windings 693C and 693D is coupled in series with a blocking diode 694 and 695. The diode-winding combinations are coupled in series with each other and across the terminals 678C and 688C. The common junction of the modules 670 and 680 (terminals 678B and 688A) is connected to the common junction of the two diode-winding combinations, between the diode 694 and the secondary winding 693C, as shown in FIG. 6. An oscillator 691 generates a signal that drives the input of the switch 692, periodically changing the state of the switch 692 from open to closed, and vice versa.

When the switch 692 is closed, the series combination of the primary winding 693B and the switch 692 is effectively connected across the terminals 678C and 688C. Thus, current sourced by the cells of the modules 670 and 680 begins to flow through the primary winding 693B. As the current increases, electric energy is converted into magnetic field energy stored in the transformer core 693A. At some point, the signal output by the oscillator 691 changes to a level that closes the switch 692. The current flow through the primary winding 693B then quickly diminishes and then stops completely. As a result, the magnetic field of the core 693A collapses, and the energy stored in the field “flies back” into secondary windings 693C and 693D, inducing voltages across each of these secondary windings. These induced voltages flow through blocking diodes 694 and 695 into the cells of the modules 670 and 680.

Because the secondary windings 693C and 693D and the primary winding 693B are magnetically coupled together, more energy tends to flow into the cell (or cells) with a relatively low voltage than into the cell (or cells) with a relatively high voltage.

The signal output by the oscillator 691 alternately opens and closes the switch 692, causing the cycles of storing energy in the magnetic field and releasing the stored energy into the secondary windings 693C and 693D to repeat, balancing the voltages of the cells in the process. Because of the presence of intra-module balancers (not shown in FIG. 6), equalizing the voltage of selected cells of the module 670 against the voltage of selected cells of the module 680 tends to equalize the total voltages of the two modules.

At times when no voltage is induced in the secondary windings 693C and 693D, the blocking diodes 694 and 695 prevent the module cells from discharging through these windings.

This document describes in some detail inventive multi-cell modules, voltage balancing circuits, and methods for balancing voltages of multi-cell modules. This was done for illustration purposes. Neither the specific embodiments of the invention as a whole, nor those of its features limit the general principles underlying the invention. In particular, the invention is not limited to the specific components described, or to particular applications. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protections afforded the invention, which function is served by the claims and their legal equivalents.

1. An electric energy storage module, comprising:
a first end terminal and a second end terminal;
a plurality of energy storage cells connected in series between the first end terminal and a second end terminal to provide voltage output from the first and the second end terminals;
a holder capable of holding the plurality of energy storage cells;
an intra-module voltage balancer capable of equalizing voltages of the energy storage cells; and
at least one intermediate terminal coupled to one or more common junction of two of the energy storage cells, wherein the first end terminal, the second end terminal, and wherein the at least one intermediate terminal are externally accessible.

2. A module according to claim 1, wherein the holder comprises an enclosure surrounding and containing the plurality of energy storage cells and the intra-module voltage balancer.

3. A module according to claim 2, wherein the plurality of energy storage cells comprises a plurality of double layer capacitors.

4. A module according to claim 2, wherein each energy storage cell of the plurality of energy storage cells comprises a capacitor.

5. A module according to claim 2, wherein the plurality of energy storage cells comprises a plurality of secondary cells.

6. A module according to claim 2, wherein the intra-module voltage balancer comprises a flyback circuit.

7. A module according to claim 2, wherein the intra-module voltage balancer comprises a shunt balancer.

8. A module according to claim 2, wherein the intra-module balancer comprises an active balancer.

9. A module according to claim 1, wherein:
the at least one intermediate terminal includes one intermediate terminal coupled to a first common junction of two of the energy storage cells; and
the first common junction is in the middle of the series of the energy storage cells so that exactly a first number of energy storage cells are present between the first common junction and the first end terminal, and exactly the first number of energy storage devices are present between the first common junction and the second end terminal.

10. A module according to claim 9, wherein the first number is equal to one.

11. A module according to claim 1, wherein:
the at least one intermediate terminal includes a first intermediate terminal coupled to a first common junction of two of the energy storage cells, and a second intermediate terminal coupled to a second common junction of two of the energy storage cells; and
a first number of energy storage cells are present between the first common junction and the first end terminal, and the first number of energy storage cells are present between the second common junction and the second end terminal.

12. A module according to claim 11, wherein the first number is equal to one.

13. A module according to claim 11, wherein the first number is greater than one.

14. An energy storage apparatus, comprising:
a plurality of energy storage modules; and
one or more inter-module voltage balancer connected to the plurality of energy storage modules to equalize voltages of the modules, wherein each module of the plurality of energy storage modules comprises:
a first end terminal and a second end terminal,
a plurality of energy storage cells connected in series between the first end terminal and a second end terminal of said each module to provide voltage output from the first and the second end terminals of said each module,
a holder capable of holding the plurality of energy storage cells of said each module, an intra-module voltage balancer capable of equalizing voltages of the energy storage cells of said each module, and
at least one intermediate terminal coupled to one or more common junction of two of the energy storage cells of said each module; and
wherein the first end terminal, the second end terminal, and the at least one intermediate terminal of said each module are externally accessible and connected to the at least one inter-module voltage balancer.

15. An energy storage apparatus according to claim 14, wherein the holder of said each module comprises an enclosure surrounding and containing the plurality of energy storage cells of said each module and the intra-module voltage balancer of said each module.

16. An energy storage apparatus according to claim 15, wherein the inter-module voltage balancer directly equalizes voltages of combinations of fewer than all cells of said each module, and indirectly equalizes voltages of the modules.

17. An energy storage apparatus according to claim 15, wherein:
the at least one intermediate terminal of said each module includes one intermediate terminal coupled to a first common junction of two of the energy storage cells of said each module; and
the first common junction of said each module is in the middle of the series of the energy storage cells of said each module so that exactly a first number of energy storage cells are present between the first common junction and the first end terminal of said each module, and exactly the first number of energy storage devices are present between the first common junction and the second end terminal of said each module.

18. An energy storage apparatus according to claim 17, wherein the first number is equal to one.

19. An energy storage apparatus according to claim 17, wherein the first number is greater than one.

20. An energy storage apparatus according to claim 17, wherein the plurality of energy storage cells of said each module comprises a plurality of double layer capacitors.

21. An energy storage apparatus according to claim 15, wherein:
the at least one intermediate terminal of said each module includes a first intermediate terminal coupled to a first common junction of two of the energy storage cells of said each module, and a second intermediate terminal coupled to a second common junction of two of the energy storage cells of said each module; and
a first number of energy storage cells are present between the first common junction and the first end terminal of said each module, and the first number of energy storage cells are present between the second common junction and the second end terminal of said each module.

22. An energy storage apparatus according to claim 21, wherein the first number is equal to one.

23. An energy storage apparatus according to claim 21, wherein the first number is greater than one.

24. An energy storage apparatus according to claim 21, wherein the plurality of energy storage cells of said each module comprises a plurality of double layer capacitors.

25. An energy storage device, comprising:
a first module comprising:
a first end terminal and a second end terminal, a first plurality of energy storage cells connected in series between the first end terminal and the second end terminal to provide voltage output from the first and the second end terminals,
a first holder capable of holding the first plurality of energy storage cells,
a first intra-module voltage balancer capable of equalizing voltages of the energy storage cells of the first plurality, and
a first intermediate terminal coupled to a common junction of two of the energy storage cells of the first plurality, wherein the first end terminal, the second end terminal, and the first intermediate terminal of the first module are externally accessible;
a second module comprising:
a third end terminal and a fourth end terminal,
a second plurality of energy storage cells connected in series between the third end terminal and the fourth end terminal to provide voltage output from the third and the fourth end terminals,
a second holder capable of holding the second plurality of energy storage cells,
a second intra-module voltage balancer capable of equalizing voltages of the energy storage cells of the second plurality, and
a second intermediate terminal coupled to a common junction of two of the energy storage cells of the second plurality, wherein the third end terminal, the fourth end terminal, and the second intermediate terminal are externally accessible; and
an inter-module voltage balancer, wherein the first module and the second module are connected in series so that the second end terminal of the first module is coupled to the third end terminal of the second module, and wherein the inter-module voltage balancer is connected to the second end terminal of the first module, the first intermediate terminal of the first module, and to the second intermediate terminal of the second module to equalize directly voltage of cells located between the first intermediate terminal and the second end terminal of the first module and voltage of cells located between the second intermediate terminal and the third end terminal of the second module.

26. The energy storage device of claim 25, wherein the first holder comprises a first enclosure surrounding and containing the first plurality of energy storage cells and the first intra-module voltage balancer, and the second holder comprises a second enclosure surrounding and containing the second plurality of energy storage cells and the second intra-module voltage balancer.

27. The energy storage device of claim 25, wherein the first plurality of cells comprises a plurality of double layer capacitors, and the second plurality of cells comprises a plurality of double layer capacitors.

28. The energy storage device of claim 25, wherein exactly one cell is located between the first intermediate terminal and the second end terminal of the first module, and exactly one cell is located between the second intermediate terminal and the third end terminal of the second module.

29. The energy storage device of claim 25, wherein exactly the same number of cells is located between the first intermediate terminal and the second end terminal of the first module as the number of cells located between the second intermediate terminal and the third end terminal of the second module.

30. The energy storage device of claim 29, wherein at least two cells are located between the first intermediate terminal and the second end terminal of the first module.

31. A method of equalizing voltages of rechargeable multi-cell modules with intra-module voltage balancers, the modules being connected in series, each module comprising a plurality of energy storage cells connected in series between a first end terminal and a second end terminal, the method comprising:
providing an inter-module voltage balancer;
connecting the inter-module voltage balancer between two adjacent modules of the plurality of modules; and
operating the inter-module voltage balancer to balance directly voltages of combinations of fewer than all cells of each module, thereby equalizing indirectly voltages of the modules.

32. An energy storage device of claim 16, wherein the inter-module balancer comprises a flyback circuit.

33. An energy storage device of claim 16, wherein the inter-module balancer comprises a shunt balancer.

34. An energy storage device of claim 16, wherein the inter-module balancer comprises an active balancer.

35. A energy storage system, comprising:
a plurality of modules, each module comprising a plurality of interconnected double-layer capacitors;
one or more intra-module balancer, wherein between each double-layer capacitor there is interconnected one intra-module balancer to equalize voltages of the double-layer capacitors; and
one or more inter-module balancer, wherein between each module there is interconnected one inter-module balancer to equalize voltages appearing across the modules.

36. The energy storage system of claim 35, wherein the plurality of modules comprise an enclosure surrounding and containing the interconnected double-layer capacitors.

37. The energy storage system of claim 35, wherein the inter-module balancer equalizes voltages across one or more double-layer capacitor in one module against voltages across one or more double-layer capacitor in a second module.

38. The energy storage device of claim 37, wherein the voltages across the one or more double-layer capacitor is less than the voltages across the modules.
